(19) United States
(12) Patent Application Publication
(10) Pub. No.: US 2025/0205934 A1
(43) Pub. Date: Jun. 26, 2025

(54) MOULD ASSEMBLY AND PROCESSING METHOD OF MOULD ASSEMBLY

(71) Applicants: Asphetek Solution (Chengdu) Ltd., Chengdu (CN); ADVANCED OPTOELECTRONIC TECHNOLOGY, INC., Hsinchu County (TW); Asphetek Solution Inc., Hsinchu (TW)

(72) Inventors: YUAN-TING LIANG, Hsinchu (TW); Chung-Wu LIU, Hsinchu (TW)

(21) Appl. No.: 18/611,911

(22) Filed: Mar. 21, 2024

(30) Foreign Application Priority Data
Dec. 25, 2023 (CN) 202323541728.9

(51) Int. Cl. B29C 33/10; B29C 33/46; B29C 33/60

(52) U.S. Cl. CPC B29C 33/10; B29C 33/46; B29C 33/60

(57) ABSTRACT

A mould assembly is provided, comprising an upper mould and a lower mould, a release film is provided between the upper mould and the lower mould, the lower mould defines a cavity for processing a workpiece, the release film covers the cavity, a bottom surface of the cavity provides an exhaust area, the exhaust area defines a plurality of exhaust grooves, the lower mould defines one or more through-holes, the plurality of exhaust grooves is communicated with the one or more through-holes, a width of each of the plurality of exhaust grooves is less than a thickness of the release film, the one or more through-holes draw the air to make the release film attach on the bottom surface of the cavity.

### FIELD

The present disclosure relates to fields of mould assembly technology, particularly to a mould assembly, and a processing method of the mould assembly.

### BACKGROUND

An existing mould assembly includes an upper mould and a lower mould, the upper mould is fitted with the lower mould. A cavity is formed between the upper mould and the lower mould. A release film covers a surface of the cavity to prevent packaging adhesive from the mould assembly.

When packaging adhesive is applied on a workpiece using the mould assembly, the workpiece is fixed to the upper mould, the upper mould is pressed to the lower mould. The mould assembly is heated to a preset temperature, and liquid packaging adhesive is dispensed into the cavity of the mould. The packaging adhesive cures from the mould's heat and forms a solid layer on the workpiece. After the upper mould and the lower mould are separated, the surface of the workpiece has a layer of the solid packaging adhesive.

When a roughness of a surface of the cavity is low, the release film and the surface of the cavity can easily form a sealed state, and some air may be trapped between the release file and the surface of the cavity. The trapped air cannot be discharged. Trapped air will affect a shape of the workpiece, resulting an uneven surface of the workpiece.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates an embodiment of a schematic view of a mould assembly in the present disclosure.

FIG. 2 illustrates a side view of a release film attached on a lower mould of the mould assembly shown in FIG. 1.

FIG. 3 illustrates a schematic view of a mould assembly core of the mould assembly shown in FIG. 2.

FIG. 4 illustrates an embodiment of a diagram view of a plurality of exhaust grooves shown in FIG. 3.

FIG. 5 illustrates an embodiment of another diagram view of a plurality of exhaust grooves shown in FIG. 3.

FIG. 6 illustrates an embodiment of a flowchart of a processing method of the mould assembly shown in FIG. 1 of the present disclosure.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein comprises any and all combinations of one or more of associated listed items.

Some embodiments of the present application are described in detail. In the case of no conflict, the following embodiments and the features in the embodiments can be combined with each other.

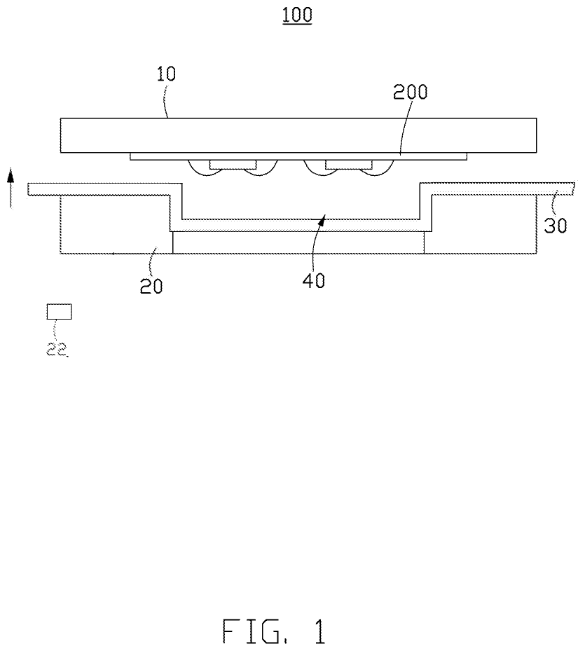

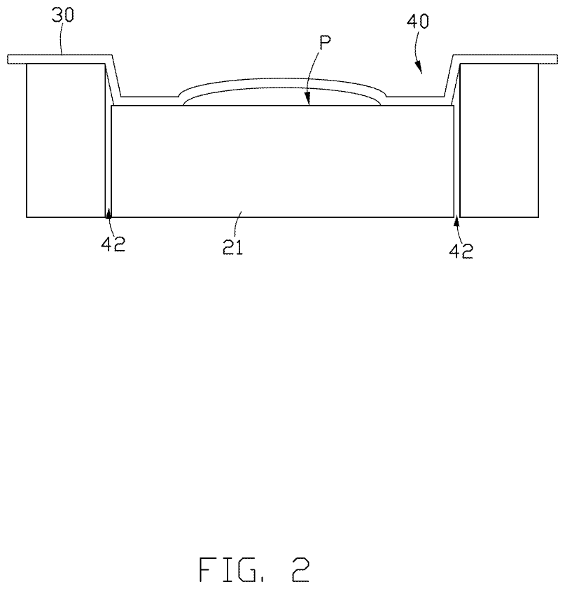

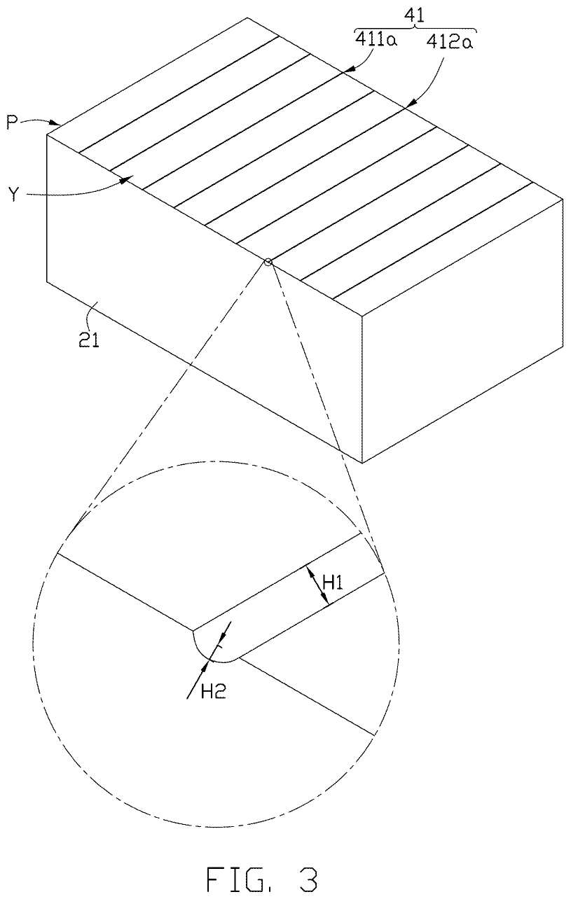

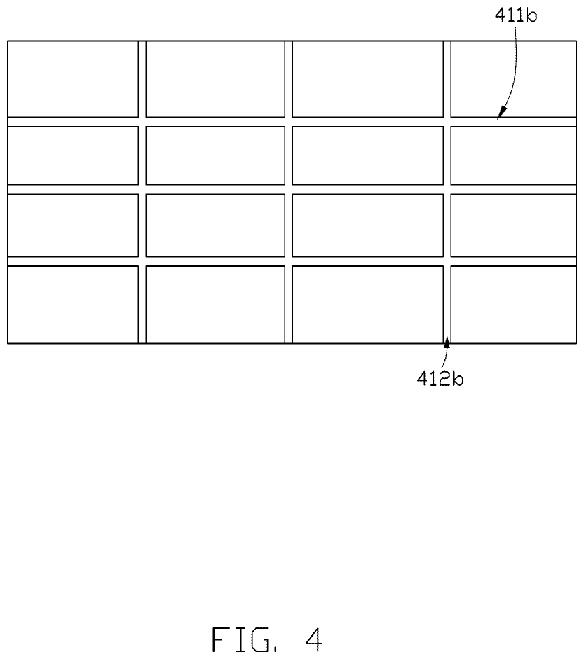

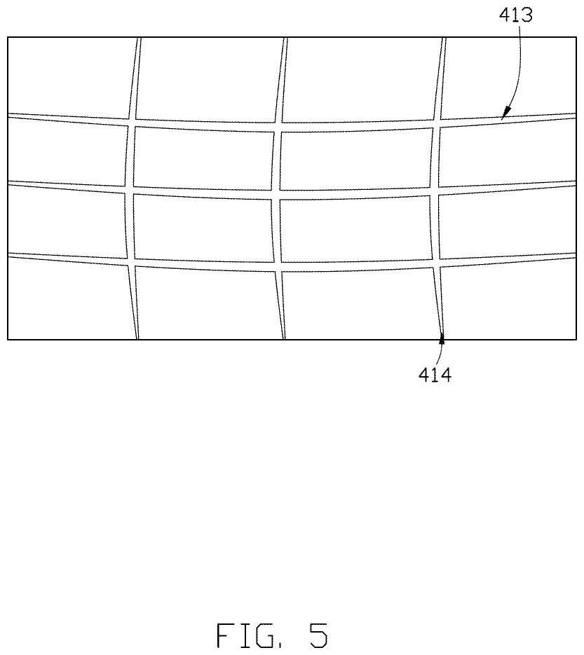

Referring to FIG. 1, FIG. 2, FIG. 3, FIG. 4, and FIG. 5, one embodiment of the present application discloses a mould assembly 100. The mould assembly 100 is configured to form sealing adhesive to protect a surface of a workpiece 200.

Referring to FIG. 1, FIG. 2, and FIG. 3, the mould assembly 100 includes an upper mould 10 and a lower mould 20. The upper mould 10 is fitted with the lower mould 20. A release film 30 is provided between the upper mould 10 and the lower mould 20, the lower mould 20 defines a cavity 40 configured for processing the workpiece 200, the release film 30 covers inner surface of the cavity 40. A bottom surface P of the cavity 40 includes an exhaust area Y, the exhaust area Y is arranged on a center of the bottom surface P of the cavity 40. The exhaust area Y defines a plurality of exhaust grooves 41, the lower mould 20 defines one or more through-holes 42. The one or more through-holes 42 is arranged on a periphery of cavity 40, the plurality of exhaust grooves 41 is communicated with the one or more through-holes 42. A width of each of the plurality of exhaust grooves 41 is less than a thickness of the release film 30 to avoid a shape of the plurality of exhaust grooves 41 affecting a packaging adhesive surface. The one or more through-holes 42 is configured to flush air thereby making the release film 30 attached to the bottom surface P of the cavity 40. The air between the release film 30 and the bottom surface P is flushed through the plurality of exhaust grooves 41, the release film 30 is tightly attach to the bottom surface P, and some bubbles between the release film 30 and the bottom surface P are eliminated.

In one embodiment, the lower mould 20 includes a mould core 21 and a vacuum driver 22. The vacuum driver 22 is arranged on one side of the mould core 21, the vacuum driver 22 is connected to the mould core 21 through pipes, and the air in the one or more through-holes 42 is removed by the vacuum driver 22. The vacuum driver 22 is a vacuum motor.

The cavity 40 is provided on a side of the mould core 21 near the upper mould 10. A part of an upper surface of the mould core 21 is the bottom surface P of the cavity 40. In a process of moulding the workpiece 200, the workpiece 200 is fixed on the upper mould 10, a liquid adhesive is placed on the release film 30 near the upper mould 10. Then, the upper mould 10 pressed the lower mould 20, the mould assembly 100 is heated to form the liquid adhesive into the solid adhesive, the solid adhesive is attached to the surface of the workpiece 200. The air between the release film 30 and the bottom surface P is flushed through the one or more through-holes 42 by the vacuum driver 22, the release film 30 is attached to the bottom surface P to improve the smoothness of the workpiece 200.

Referring to FIG. 3, the width of each of the plurality of exhaust grooves 41 is marked as a first width H1, the first width H1 is in a range between 0.01 μm-50 μm. In one embodiment, the first width H1 is 0.05 μm, 10.00 μm, 15.00 μm, 20.00 μm, 35.00 μm or 48.00 um. A depth of each of the plurality of exhaust grooves is marked as a first depth H2, the first depth H2 is in a range between 0.01 μm-30 μm. In one embodiment, the first depth H2 is 0.08 μm, 1.09 μm, 6.25 μm, 15.63 μm or 18.00 μm. On the one hand, a problem of the plurality of exhaust grooves 41 affecting the smoothness of the workpiece 200 can be avoid. On the other hand, a problem of the plurality of exhaust grooves 41 affecting a yield of the workpiece 200 can be avoid.

In one embodiment, a ratio of an acreage of the exhaust area Y to an acreage of the bottom surface P of the cavity 40 is not more than 10%. If the ratio is too large, the plurality of exhaust grooves 41 may cause the release film 30 to warp, the liquid adhesive makes the workpiece 200 to form a bumpy surface. If the ratio is too small, the bubbles between the release film 30 and the bottom surface P cannot be removed to make the workpiece 200 to form a bumpy surface. In some embodiments, a shape of a cross section of one of the plurality of exhaust grooves 41 is a semi-circular, a triangular or a quadrilateral. In other embodiments, the shape of the cross section of an acreage of the plurality of exhaust grooves 41 can be irregular figures or polygons.

Referring to FIG. 2 and FIG. 3, the plurality of exhaust grooves 41 includes a first exhaust groove 411a and a second exhaust groove 412a, a shape of the first exhaust groove 411a and a shape of the second exhaust groove 412a is a straight-line. The first exhaust groove 411a and the second exhaust groove 412a are parallel, the first exhaust groove 411a is spaced from the second exhaust groove 412a, and the first exhaust groove 411a and the second exhaust groove 412a are communicated with the one or more through-holes 42. The air in the first exhaust groove 411a and the second exhaust groove 412a can be flushed through the one or more through-holes 42.

Referring to FIG. 2 and FIG. 4, the plurality of exhaust grooves 41 includes a first exhaust groove 411b and a second exhaust groove 412b, one end of the first exhaust groove 411b is communicated with the one or more through-holes 42, another end of the first exhaust groove 411b crosses the second exhaust groove 412b. Air can be flushed through the first exhaust groove 411b and the second exhaust groove 412b.

In another embodiment, referring to FIG. 5, the plurality of exhaust grooves 41 includes a third exhaust groove 413 and a fourth exhaust groove 414. A shape of the third exhaust groove 413 and a shape of the fourth exhaust groove 414 is an arc. One end of the third exhausted groove 413 is communicated with the through-hole 42, another end of the third exhausted groove 413 is crossed with the fourth exhausted groove 414. In one embodiment, the air is flushed through the third exhaust groove 413 and the fourth exhaust groove 414.

In other embodiments, the shape of each of the plurality of exhaust grooves 41 can be serrated, multiple serrated exhaust grooves 41 can be relatively parallel and be communicated with the one or more through-holes 42. In another embodiment, part of the exhaust grooves 41 is interlaced with another part of the exhaust grooves 41, part of the exhaust grooves 41 is communicated with the one or more through-holes 42.

In one embodiment, the plurality of exhaust grooves 41 can be empty or be filled with stuffing, the air in the plurality of exhaust grooves 41 is flushed through the stuffing in the plurality of exhaust grooves 41 and the one or more through-holes 42. The stuffing can be a ceramic material, a metal foam material, or a metal-organic frame material. The air in the release film 30 and the bottom surface P can be flushed through the plurality of exhaust grooves 41 and the one or more through-holes 42.

In the mould assembly 100, the lower mould 20 defines the one or more through-holes 42, the bottom surface P defines the plurality of exhaust grooves 41, the air in the release film 30 and the bottom surface P can be flushed through the plurality of exhaust grooves 41 and the one or more through-holes 42. The ratio of the acreage of the exhaust area Y to the acreage of the bottom surface P of the cavity 40 is not more than 10%, the first width H1 is in a range with 0.01 μm-50 μm, the first depth is in a range between 0.01 μm-30 μm, a problem of air not being flushed through the release film 30 and the bottom surface P of the cavity 40 can be avoid, a problem of uneven surface of the workpiece 200 can also be avoided.

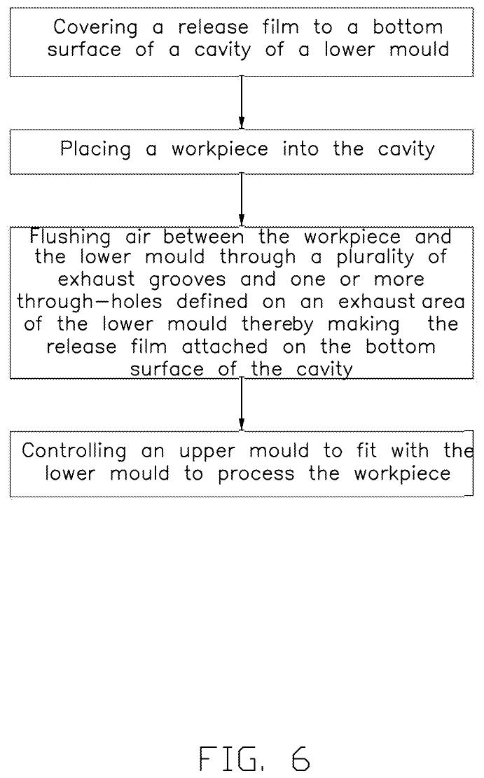

In one embodiment, referring to FIG. 6, the present application also discloses a processing method of a mould assembly. During the processing method of the mould assembly, the release film 30 is covered to the bottom surface P of the cavity 40, the workpiece 200 is placed into the cavity 40. Then, air is flushed through the plurality of exhaust grooves 41 and the one or more through-holes 42 to make the release film 30 attach on the bottom surface P of the cavity 40. The upper mould 10 presses the lower mould 20 to process the workpiece 200.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A mould assembly comprising:
an upper mould,
a lower mould, and
a release film, wherein the release film is provided between the upper mould and the lower mould, the lower mould defines a cavity configured for processing a workpiece, the release film covers the cavity, a bottom surface of the cavity comprises an exhaust area, the exhaust area defines a plurality of exhaust grooves, the lower mould further defines one or more through-holes, the plurality of exhaust grooves is communicated with the one or more through-holes, a width of each of the plurality of exhaust grooves is less than a thickness of the release film, the one or more through-holes is configured to flushing air thereby making the release film attached to the bottom surface of the cavity.

2. The mould assembly as claimed in claim 1, wherein the width of each of the plurality of exhaust grooves is in a range between 0.01 μm-50 μm.

3. The mould assembly as claimed in claim 1, wherein a depth of each of the plurality of exhaust grooves is in a range between 0.01 μm-30 μm.

4. The mould assembly as claimed in claim 1, wherein a ratio of an acreage of the exhaust area to an acreage of the bottom surface of the cavity is not more than 10%.

5. The mould assembly as claimed in claim 1, wherein a shape of a cross section of one of the plurality of exhaust grooves is a semi-circular, a triangular or a quadrilateral.

6. The mould assembly as claimed in claim 1, wherein the plurality of exhaust grooves comprises a first exhaust groove and a second exhaust groove, a shape of the first exhaust groove and a shape of the second exhaust groove is a straight-line.

7. The mould assembly as claimed in claim 6, wherein the first exhaust groove and the second exhaust groove are parallel, the first exhaust groove is spaced from the second exhaust groove, the first exhaust groove and the second exhaust groove are communicated with the one or more through-holes.

8. The mould assembly as claimed in claim 6, wherein one end of the first exhausted groove is communicated with the one or more through-holes, another end of the first exhausted groove crosses with the second exhausted groove.

9. The mould assembly as claimed in claim 1, wherein the plurality of exhaust grooves comprises a third exhaust groove and a fourth exhaust groove, a shape of the third exhaust groove and a shape of the fourth exhaust groove is an arc.

10. The mould assembly as claimed in claim 9, wherein one end of the third exhausted groove is communicated with the one or more through-hole, another end of the third exhausted groove crosses with the fourth exhausted groove.

11. The mould assembly as claimed in claim 1, wherein the plurality of exhaust grooves is filled with stuffing, the air in the plurality of exhaust grooves flushed through the stuffing in the plurality of exhaust grooves and the one or more through-holes.

12. The mould assembly as claimed in claim 1, wherein the one or more through-holes are located on a circumferential side of the cavity.

13. A processing method of a mould assembly, the processing method comprising:
covering a release film to a bottom surface of a cavity of a lower mould;
placing a workpiece into the cavity;
flushing air between the workpiece and the lower mould through a plurality of exhaust grooves and one or more through-holes defined on an exhaust area of the lower mould thereby making the release film attached on the bottom surface of the cavity;
controlling an upper mould to fit with the lower mould to process the workpiece.

14. The processing method of the mould assembly as claimed in claim 13, wherein a width of each of the plurality of exhaust grooves is in a range between 0.01 μm-50 μm.

15. The processing method of the mould assembly as claimed in claim 13, wherein a depth of each of the plurality of exhaust grooves is in a range between 0.01 μm-30 μm.

16. The processing method of the mould assembly as claimed in claim 13, wherein a ratio of an acreage of the exhaust area to an acreage of the bottom surface of the cavity is not more than 10%.
